(19) United States
(12) Patent Application Publication
(10) Pub. No.: US 2002/0149777 A1
(43) Pub. Date: Oct. 17, 2002

(54) Support for a movable mirror in an interferometer

(76) Inventor: Kenneth C. Schreiber, Sandy Hook, CT (US)

Correspondence Address: CALFEE HALTER & GRISWOLD, LLP, 800 SUPERIOR AVENUE, SUITE 1400, CLEVELAND, OH, 44114, US

(21) Appl. No.: 09/833,893

(22) Filed: Apr. 12, 2001

(51) Int. Cl. G01B 9/02

(52) U.S. Cl. 356/452

(57) ABSTRACT

A multiple spring support for a displaceable mirror in an interferometer maintains the plane in which the flat mirror surface resides perpendicular to the centerline of a wave front at all retardations of the interferometer. In its simplest configuration, two equal length spring sections are connected to a movable rigid beam section at one end of the spring sections and are connected to a fixed rigid base section at the other end of the spring sections. The spacing between spring sections at the movable rigid beam section being the same as the spacing between spring sections at the fixed rigid base section.

### FIELD OF INVENTION

This invention relates to an apparatus for supporting a movable mirror assembly with the apparatus finding advantageous use in an interferometer.

### BACKGROUND OF THE INVENTION

In an interferometer, a movable mirror is used to cause constructive and destructive interference between two radiation beams derived from a common source at different movable mirror displacements, or different retardations. The resulting radiation is said to be modulated.

Various methods have been used to provide bearing support for a movable mirror assembly that attempt to maintain mirror surface perpendicularity to a wave front either while the mirror assembly is moving, or for different displacements of the movable mirror. Air bearings have been widely used for high-resolution mid and near infrared interferometers, but the need for high quality gas is expensive and air bearings are cumbersome. “Porch swing” linkages have been used with success, but are relatively expensive and require great effort and attention to assure proper setup. U.S. Pat. No. 4,991,961 to Strait discloses a moving mirror tilt adjust mechanism in an interferometer to assure such proper alignment. More recently, a glass graphite bearing has been used with success (U.S. Pat. No. 5,896,197). Linear ball bearings are now available that provide acceptable smoothness and linearity, however they are moderately expensive and require great attention to manufacturing tolerances and cleanliness.

U.S. Pat. No. 4,710,001 to Lacey discloses a moving mirror assembly using a pair of flat springs “created by forming a plurality of open-ended slots in a flat sheet of spring stock, each slot partially enclosing the next innermost slot” (Col. 2, lines 61-64). A frame holds one edge of each spring to position the same within opposed apertures in the frame sidewalls, and a hollow rectangular beam extends between the centers of the springs. While the patent meets the functional criteria required of a moving mirror assembly, it suffers from being overly complex and is subject to environmental influences such as vibrations and external shocks.

The invention disclosed herein greatly simplifies a movable mirror apparatus and provides a low cost, significantly more robust interferometer, which is less subject to environmental shock and vibrations.

### SUMMARY OF THE INVENTION

The present invention is a device for supporting a mirror in an interferometer or other application so that the plane in which the mirror surface resides can be moved perpendicular to a wave front without tilting or wobbling. The invention meets the requirement for a flat moving mirror used in an interferometer, that is, that the plane which contains the mirror surface remains perpendicular to the wave front for all displacements. This condition is met for our invention even though the actual mirror does not move in a straight-line, but instead in an arc-wise fashion.

The apparatus can be used in a fast-scan interferometer where measurements are made while the movable mirror is moving at a constant linear velocity, or with all other interferometers, such as a step-scan interferometer, where the movable mirror is moved to a position, stopped while a measurement is made and then moved to another position.

The present invention discloses the use of springs as part of a movable mirror mechanism for use in an interferometer. When using the term spring, we mean an elastic element that in whole or in part returns substantially to its original form after being forced out of shape. By such definition, the term spring would clearly include metals, plastics, rubbers and other widely accepted elastic materials and would also include such materials as sheet paper or thin sheets of certain other fibrous materials. While paper and certain other fibrous materials are not considered to be highly elastic, they do exhibit the property of substantially returning to their original forms when the sheets are curled or bent but not folded, creased, or otherwise bent beyond their elastic limits.

While the preferred embodiment shown uses only two springs, it is contemplated that embodiments with more than two springs will exhibit beneficial robustness to external disturbances at low to modest increases in cost. It is also envisioned that flat springs can be replaced with multiple spring steel wires, which are clamped in a fashion similar to that of the flat springs and thereby provide a variation of the preferred embodiment. Furthermore it is contemplated that a significant portion of the movable mirror apparatus can be cast, molded, or extruded out of materials with appropriate elasticity in order to further simplify the apparatus and reduce costs. Two such embodiments are disclosed in FIGS. 4 and 5.

Because the apparatus is simple and has no parts that exhibit wear characteristics, it is expected that there are additional benefits of low maintenance and durability. Furthermore, since the springs are minimally stressed, it is expected that there will be no deterioration over time and that the movable mirror mechanism will thereby be highly stable over time.

While the movable mirror mechanism is very simple and low cost, it is highly precise and repeatable even over the greater displacements required for high resolution instruments, which historically have required the use of high cost air bearing systems.

The two springs supporting the rigid beam and mirror are spaced apart an equal amount at the rigid beam connection and at the frame connection. For the preferred embodiment, during assembly, the spring connections in the at-rest mode are adjusted to cause the springs to be parallel to each other, such that in a side elevation, the lines which can be drawn between adjacent points of the four spring connections define a parallelogram. Meeting these aforementioned conditions causes parallelograms to be defined by lines drawn between adjacent points of the four spring connections at all displacements of the mirror and rigid beam so long as the elastic limits of the springs are not exceeded. This equal spacing of the connections of the springs contributes to the plane of the mirror surface remaining parallel to all other planes in which the mirror resides for all displacements of the rigid beam and mirror assembly permitted by elastic displacement of the springs.

### BRIEF DESCRIPTION OF THE DRAWINGS

In the drawings:

FIG. 1 is an isometric view of the preferred embodiment of the support device along with the drive magnet housing assembly for an interferometer;

FIG. 2 is a side elevation showing the support device of FIG. 1 in its upright, at rest position, with the drive magnet housing assembly being shown in section;

FIG. 3 is a side elevation showing flat spring deflection as it would appear from displacement of the beam and attached mirror during movement or at different retardations, with the at rest position being shown in dashed lines; and with magnet and magnet housing not being shown for clarity of illustration;

FIG. 3A is an enlarged, partial side elevation showing a series of different displacements of the flat springs;

FIG. 3B is similar to FIG. 2, and shows the beam and flat springs at rest, with a rectangular parallelogram defined by connection points A, B, C, and D of the springs;

FIG. 3C is similar to FIG. 3, and shows the beam displaced and the resulting parallelogram defined by connection points A, B, C, and D of the corresponding deflected flat springs;

FIG. 4 is a side elevation showing an alternative embodiment that includes an extruded one piece support member that combines a number of components disclosed in the preferred embodiment;

FIG. 5 is a side elevation of one variation of an extruded one piece support member; and

FIG. 6 is a top plan view of the preferred embodiment of the support device shown as part of an interferometer.

### DETAILED DESCRIPTION OF THE INVENTION

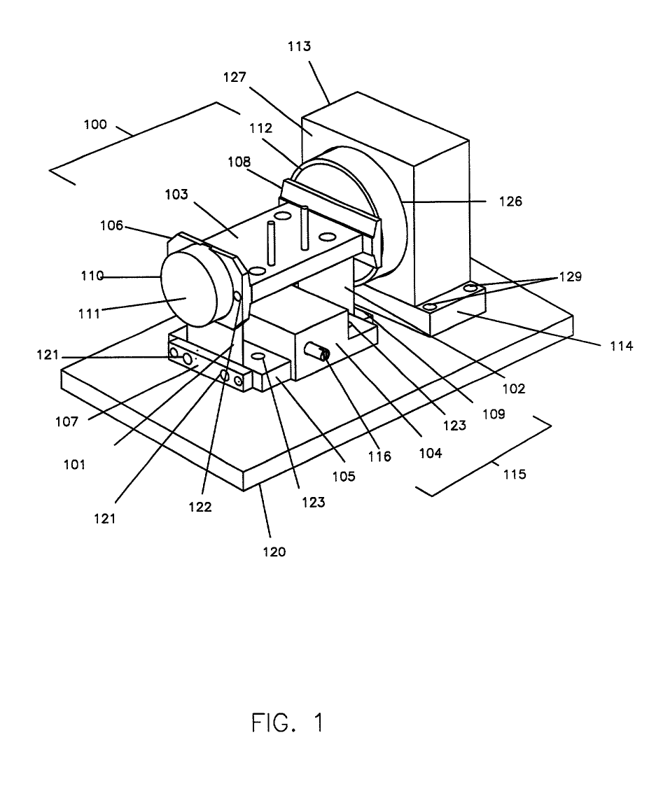

FIG. 1 discloses an isometric view of the preferred embodiment of the support device in an orientation showing the movable mirror portion above the frame; such orientation is for convenience of description only since the apparatus is capable of functioning in any orientation. As shown in the at-rest condition illustrated in FIG. 1, the movable mirror assembly, indicated generally at 100, includes two spaced, vertically extending springs 101 and 102. These springs are preferably made from spring steel and have a thickness in the range of 0.001 to 0.010 inches, with a preferred thickness of 0.003 inches. While rectangular, thin, flat springs 101 and 102 are illustrated and described, it will be appreciated that other spring shapes can be used. For example, when viewed from the left end in FIGS. 1-3, the springs 101 and 102 may have triangular, trapezoidal, and semicircular shapes as well as variations of other multisided shapes. The springs 101 and 102 also could include cut out sections in symmetrical or unsymmetrical patterns. Furthermore certain benefits could be achieved if the thickness of the springs is made different in some sections of the springs to achieve the correct combination of resistance to forces from a variety of directions along with maintaining flexibility in the direction of desired displacement.

The lower ends of springs 101 and 102 are preferably tightly secured by a clamping assembly, indicated generally at 115, to a fixed frame 120 of the interferometer. The clamping assembly 115 includes an adjustment block 104, a spacer block 105 and two spaced clamp plates 107 and 109 positioned at opposite sides of the clamping assembly 115. The bottom end of spring 101 is sandwiched between the clamp plate 107 and the spacer block 105, which is attached to frame 120 by fasteners 123. The lower end of spring 102 is sandwiched between the adjustment block 104, which is securely attached to frame 120 with fasteners 123, and clamp plate 109. The clamp plates 107 and 109 are held in compression against the bottoms of springs 101 and 102, respectively, by fasteners 121 at one end, and similar fasteners 121 at the other end. Other methods of clamping or securing the bottom ends of the springs to the clamping assembly and frame are also contemplated, such as fasteners 121 extending through the springs and the clamping assembly, or by welding, or otherwise affixing the bottom ends of the springs 101 and 102 directly to the frame. As an alternative to adjustment block 104, the spacing between the clamped lower ends of the springs 101 and 102 can be made of a single member having the same precise dimensions as the length of beam 103 between the springs 101 and 102.

The other or upper ends of springs 101 and 102 are respectively clamped to a rigid, but movable, fixed length beam 103. At its upper end, spring 101 is clampingly secured or sandwiched, between one end of the fixed length beam 103 and a mirror holder plate 106. At its upper end, spring 102 is sandwiched between the other end of the fixed length beam 103 and a coil mount plate 108. The mirror holder plate 106 and the coil mount plate 108 are held in compression against the top ends of springs 101 and 102 by fasteners 122 passing through the entire upper clamping assembly. As with the lower clamping assembly, the upper clamping assembly can be readily modified to have different spacing between the springs, to have different clamping arrangements, and to have alternate means of connecting the upper ends of the springs to the rigid beam 103.

The spacing between the upper ends of the springs 101 and 102 at their respective connections to the beam 103 equals the spacing between the springs 101 and 102 at their respective connections to the clamping assembly 115, which is rigidly mounted to fixed frame 120. The sections of the springs 101 and 102 between their respective upper and lower clamped ends are unimpeded and are thus free to flex when the rigid beam 103 is displaced or moves. When viewed in side elevation, lines drawn between the four connections of the springs 101 and 102 to the rigid beam and clamp assembly cooperatively define a parallelogram for all displacements of the mirror 110.

While two spaced, rectangular springs 101 and 102 are illustrated, it will be appreciated that additional parallel springs could be added as required for the application. For example, four rectangular corner springs of reduced width could also be used to support the rigid beam and mirror (not shown). Also, pre-bent springs could be used instead of the flat rectangular springs shown (not shown).

Mirror 110, with reflective surface 111 facing outward, is affixed to mirror holder plate 106. The mirror 110 is thus affixed to one end of and moves with the rigid beam 103.

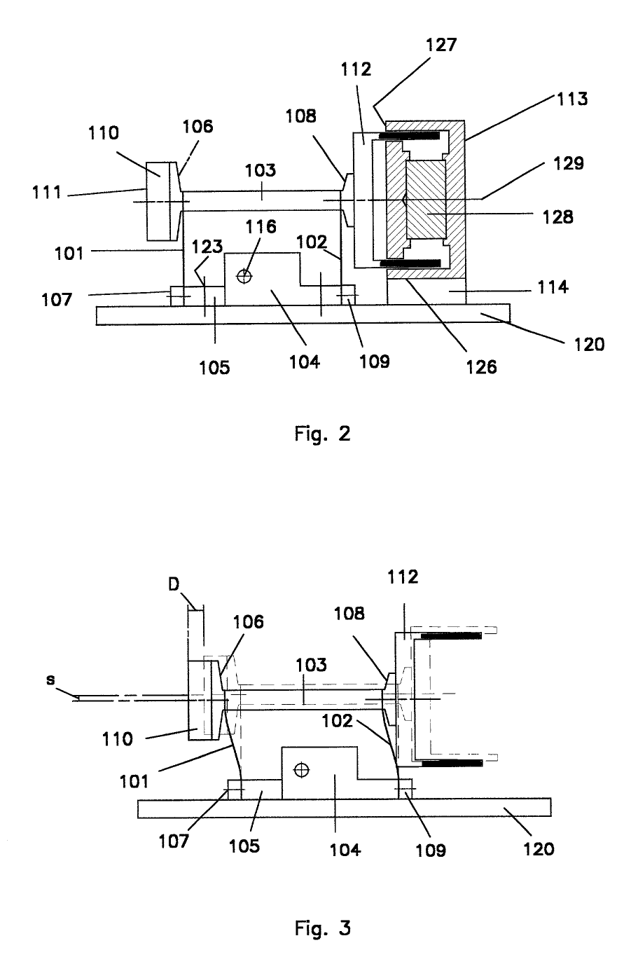

On the opposite end of the beam 103 is an annular voice coil 112 that is attached to coil mount 108. The voice coil extends into an aperture 126 in sidewall 127 of magnet housing 113. As best shown in FIG. 2, the voice coil 112 (with the actual annular electrical coils being illustrated as a blackened rectangle in section) surrounds a permanent magnet 128, which is fixedly mounted within the housing 113. The magnet housing 113 is shown attached to magnet housing adapter plate 114, which is attached to fixed frame 120 by fasteners 129 (FIG. 1).

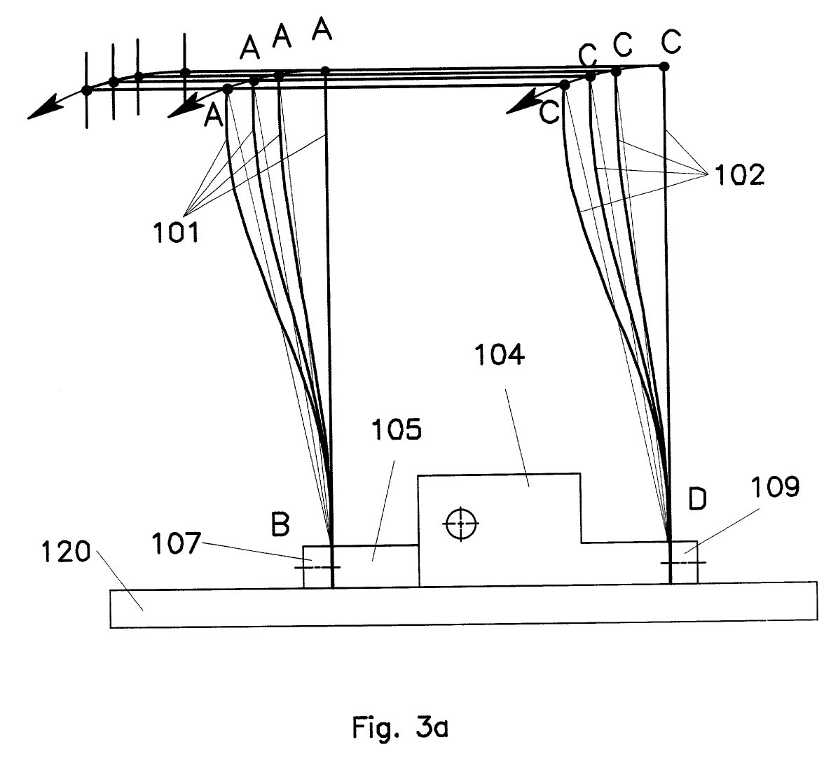

To remotely control movement of the mirror 110, an electrical current is passed through the voice coil 112. The electrical current can be passed through the electrical coils in either direction to electro-magnetically displace the rigid beam 103 and mirror 110 in either the left or right direction as viewed in FIG. 3. The speed and acceleration of displacement is dependent upon the magnitude of the current and the resistance or assistance of the springs 101 and 102 along with the respective masses of the movable mirror components.

For rapid scan interferometers, a laser 201 or other optical referencing method is used to observe the position of mirror 110 while a very fast clock is used to provide time for a velocity reference of mirror 110 in a servo loop control circuit. Such methods of velocity or position control are well known to those of ordinary skill in the art, for example, Nichols U.S. Pat. No. 3,488,123 describes such a mechanism. This patent is incorporated herein by reference. There are other schemes, well known in the art, that can be used to sense displacement or velocity of movement of mirror 110 and thereby control the mirror position or the velocity of mirror movement via the amount of current passed through the voice coil 112.

The various members of the movable mirror assembly 100 are designed to assure that driving forces are countered with opposing forces substantially along the same axis. The centers of mass of the various components of the movable beam and mirror assembly, with the exception of springs 101 and 102, lie along an extension of the cylindrical axis of the voice coil 112 and the magnet 128, which share a substantially common axis 129 (FIG. 2), thereby causing forces due to acceleration to lie along that same common axis. Due to the novel configuration of the springs 101 and 102 relative to the beam 103 and the clamping assembly 115, the external force resulting from the displacement of the movable portion of the movable mirror assembly 100 is best represented by a resultant force along the longitudinal axis 129 of the voice coil 112. As best shown in FIGS. 3 and 3A, the bending of spaced springs 101 and 102 allows the fixed beam 103 and mirror 110 to be displaced in an arc, with the beam 103 retaining its horizontal orientation during all displacements (see FIG. 3A and the arcs defined by connection points A and C, of spring 101 and 102, respectively to beam 103, at incremental displacements). In longitudinal cross sectional view, the spring connections to the frame and rigid beam cooperatively define a parallelogram at all positions of displacement (see parallelograms having four corners defined by points A, B, C, and D in FIGS. 3B and 3C).

While the resulting direction of the opposing force from the springs 101 and 102 remains along the longitudinal axis of the voice coil 112 for all displacements, the movable portion of the movable mirror assembly 100 actually moves in an arc-wise path, thereby causing the centerlines of the voice coil 112 and the magnet to separate by a small amount, as represented by the dimension S in FIG. 3. Since the lengths of the springs 101 and 102 can readily be changed by design, the amount of the centerline separations can also be changed. Also, the total displacements required depend upon the optical frequencies of interest and the measurement resolutions desired. For example, in one embodiment for use in a Fourier Transform Mid Infrared Modulator, a four wave number resolution requires a total displacement of around two to three millimeters. With this displacement, which is represented by the dimension D in FIG. 3, the centerline of the voice coil diverges from that of the fixed position magnet by less than one tenth of a millimeter, which has been found to be irrelevant to the measurements being made.

In order to insure that the necessary dimensional conditions have been met which result in wobble and tilt free movement, a separation adjustment assembly may be provided. During manufacturing, the movable mirror assembly 100 and frame 120 are placed into an alignment fixture to position the mirror surface 111 perpendicular to a collimated beam. While oscillating the movable mirror, the adjustment screw 116 is turned clockwise or counterclockwise to drive a wedge assembly (not shown), which causes the adjustment block 104 to be shifted left or right relative to the spacer block 105, as viewed in FIG. 2, to control the spacing between the frame connections of the two springs. The spacing of the springs 101 and 102 is adjusted until an acceptable level of wobble and tilt is observed from any misalignment of the images created from the collimated source radiation and the returned reflected radiation from mirror surface 111. When proper alignment is achieved the images remain aligned and do not move during the oscillation. At which time, adjustable block 104, along with spring 102 and clamp plate 109, is rigidly affixed to the frame by securely tightening fasteners 123.

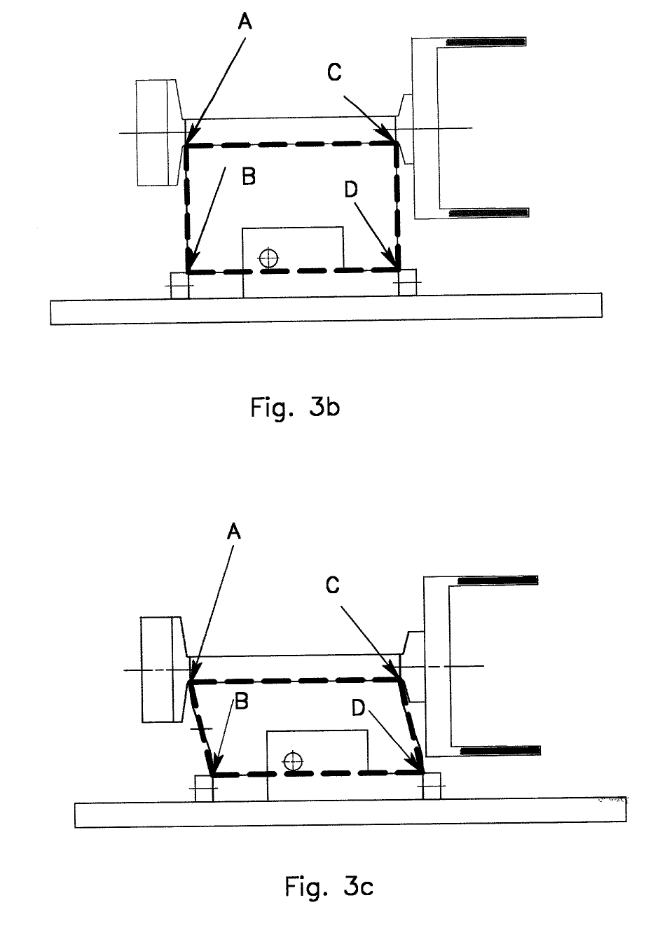

FIG. 4 discloses an embodiment wherein the use of extrusion, molding, or cold rolling techniques to manufacture the apparatus further simplifies the apparatus and reduces costs. Mirror 110 and voice coil 112 are affixed to an extruded one piece support member 130, which is affixed to frame 120 with fasteners 123. Extruded support member 130 is integrally comprised of rigid beam section 131, rigid mount 134 and spring sections 132 and 133 interconnecting the rigid beam and mount. The spring sections 132 and 133 are shown to be thin and of constant and equal thicknesses; however, spring sections 132 and 133 need not be of constant or equal thickneses. The criteria that must be met are that the effective lengths of the springs are the same and the elastic limits of the materials are not exceeded for the required maximum displacements. Extrusion and molding techniques are routinely used to create shapes of polymer, glass, and ceramic materials. Very tight tolerances can be maintained using commercially available technologies. There are currently many highly stable elastic polymers commercially available that would readily provide the properties necessary to extrude or otherwise mold the sections disclosed. In addition, dies for either extruded or molded support members can be designed and manufactured at reasonable costs.

Cold rolled forming techniques are routinely used to form shapes and to create special metallurgical properties for metals and could be readily adapted for support members made of metals.

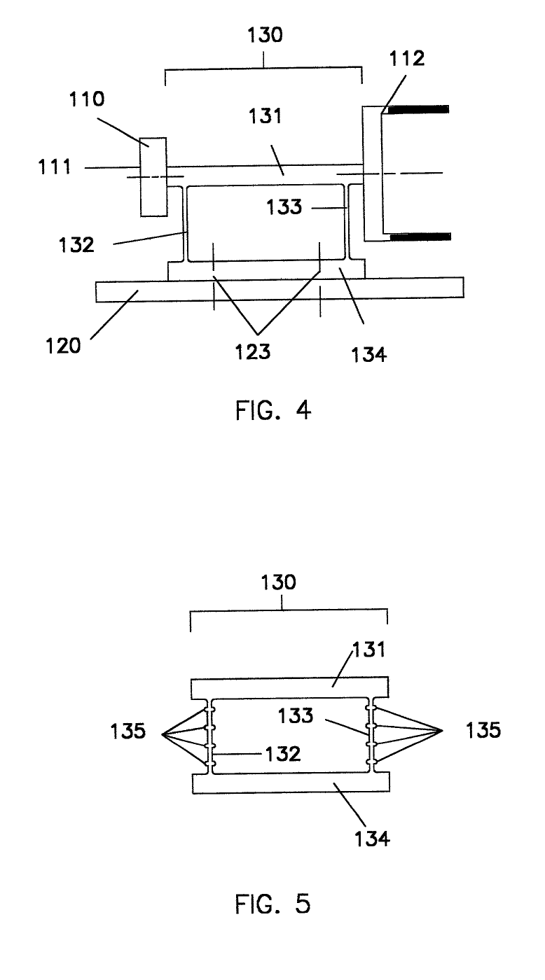

FIG. 5 discloses a side view of an extruded one piece support member with springs that are not of constant thickness but have increased modulus sections 135 to improve the support member's resistance to external shocks and vibrations while maintaining sufficiently low resistance to bending along the direction of preferred mirror movement. The integral one piece support members 130 illustrated in FIGS. 4 and 5 have the spacing between spring sections 132 and 133 at the rigid beam section 131 equal to the spacing between the spring sections at the rigid mount section 134.

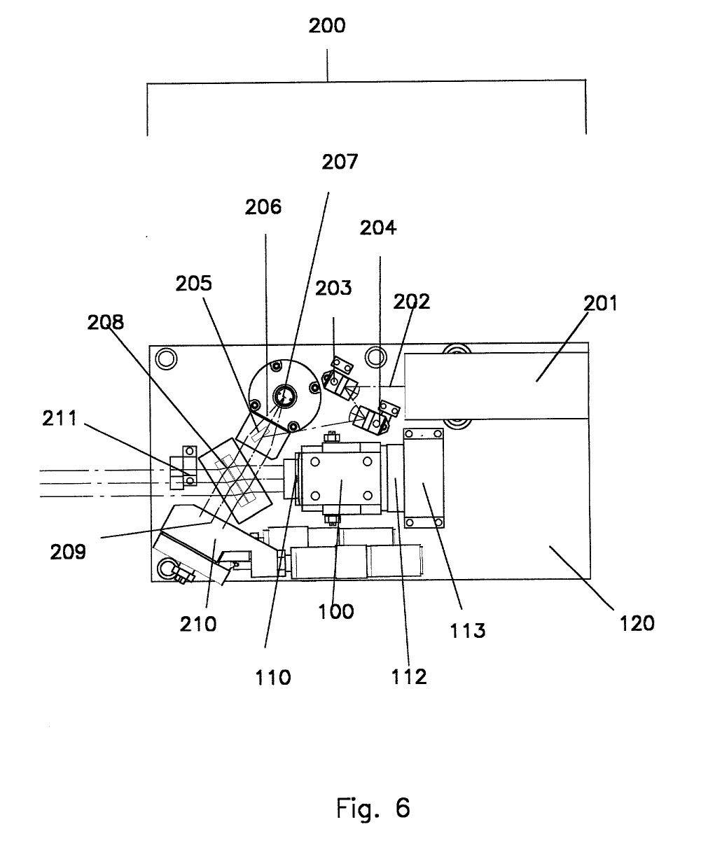

FIG. 6 discloses the movable mirror apparatus as an integral part of a Fourier Transform Infrared (FTIR) interferometer whose opto-mechanical apparatus is shown generally as 200. A laser 201 is used as an optical reference. Laser energy 202 is sequentially directed to laser steering mirrors 203, 204, and 205 to be made parallel with optical energy 206 emitted from infrared source 207. The laser energy 202 from the laser 201 and optical energy 206 from the infrared source 207 together simultaneously pass through, and are reflected off of, beam splitter 208 to fixed mirror 209 and movable mirror 110. Fixed mirror 209 is attached to mirror support assembly 210, which in turn is affixed to frame 120. Movable mirror 110 is an integral part of movable mirror assembly 100 previously described.

The laser energy 202 passes through and is reflected off of beam splitter 208 to fixed mirror 209 and movable mirror 110. The split laser energy reflects off of mirrors 209 and 110, is recombined at beam splitter 208 and then continues on to laser signal detector 211. The detector 211 converts optical energy to an electrical signal that is used by the electronic control circuitry to send electrical current to voice coil 112. This current creates an attractive or repulsive force with magnet 128 (which is contained within magnet housing 113) to control the displacement and velocity of movable mirror assembly 100. Infrared energy 206 likewise passes through and is reflected off of beam splitter 208 to fixed mirror 209 and movable mirror 110. The split infrared energy 206 is reflected off mirrors 209 and 110 and then is recombined at beam splitter 208. The infrared energy is thereby modulated as the result of the constructive and destructive interferences caused by the change in the movable mirror optical path length for different retardations. Such modulated infrared energy continues past laser detector 211 on to a detecting system (not shown). The design of the detecting system is dependent upon the experiment or experiments of interest. FTIR and FT-NIR detecting systems are well known and widely used commercially.

Although one embodiment of this invention has been shown and described, various adaptations and modifications can be made without departing from the scope of the invention as defined in the appended claims.

We claim:

1. A support for a movable mirror operative to keep each plane assumed by the mirror surface parallel to every other plane assumed by that mirror surface at different displacements comprising:
at least first and second springs spaced from one another;
one end of each of said spaced springs being connected to a fixed frame;
the other end of each of said spaced springs being connected to a displaceable rigid beam;
the spacing of the springs between the connections to the frame at said one end substantially equaling the spacing of the springs between the connections to the rigid beam at said other end; and
a mirror mounted to the rigid beam.

2. The support of claim 1 wherein said one end of said first and second springs is connected to said fixed frame by a first clamping assembly.

3. The support of claim 2 wherein said first clamping assembly further includes an adjustment mechanism selectively to vary the spacing between the first and second springs.

4. The support of claim 2 wherein said first clamping assembly further includes an adjustment block, a spacer block and first and second spaced clamping plates.

5. The support of claim 4 wherein said first clamping assembly further includes said one end of one of the first or second springs being sandwiched between said spacer block and said first clamping plate and said one end of said other of the first or second springs being sandwiched between said adjustment block and said second clamping plate.

6. The support of claim 1 wherein said other ends of said first and second springs are connected to the rigid beam by a second clamping assembly.

7. The support of claim 6 wherein said mirror is mounted on a mirror holder plate forming part of said second clamping assembly, with the other end of one of the first or second springs being clamped between the mirror holder plate and one end of the rigid beam.

8. The support of claim 6 wherein said second clamping assembly further includes a coil mount plate, the other end of the other of said first or second springs being clamped between one side of the coil mount plate and the other end of said rigid beam.

9. The support of claim 8 further comprising a drive, the drive including a voice coil mounted to the opposite side of the coil mount plate from the clamped spring end, the voice coil extending into a magnet housing and surrounding a permanent magnet mounted within that housing.

10. The support of claim 9 wherein the drive includes a current selectively passed in either direction through said voice coil to electro-magnetically control the speed, direction and amount of displacement of the rigid beam.

11. The support of claim 1 wherein said springs are flat, made from spring steel and are two in number

12. The support of claim 1 wherein said spaced springs are flat, made from spring steel and are greater in number than two.

13. The support of claim 1 wherein said one end of each of said first and second springs is connected to a fixed mount section, which in turn is secured to the fixed frame.

14. The support of claim 13 wherein said rigid beam, first and second springs and said fixed mount section are made as one integral piece.

15. The support of claim 14 wherein said integral piece is made of plastic.

16. The support of claim 14 wherein said integral piece is elastomeric.

17. The support of claim 14 wherein said integral piece is ceramic.

18. The support of claim 1 wherein said springs have varying thickness along their lengths.

19. A support for a movable flat mirror in an interferometer comprising:
a rigid mount section;
a movable rigid beam having the mirror mounted thereon and being spaced from the rigid mount section; and
at least two spaced springs respectively connected to and extending between the rigid mount section and the rigid beam, with the connection points of the springs to the rigid mount section and rigid beam cooperatively defining the four corners of a parallelogram for all displacements of the beam and mirror.

20. The support of claim 19 wherein the rigid mount section, rigid beam and the at least two springs are of one piece construction.

21. The support of claim 20 wherein the rigid mount section is secured to a frame of the interferometer.

22. The support of claim 20 wherein the one piece construction is made from one material out of a group of materials including elastic polymers, glass, ceramics, metals and papers.

23. An interferometer including a support for a movable flat mirror operative to maintain each plane assumed by the mirror surface parallel to every other plane assumed by that mirror surface at different displacements comprising: a movable rigid beam, the mirror being mounted on the rigid beam, a frame, and at least two spaced springs respectively connected to and extending between the frame and rigid beam to moveably support the mirror, the spacing of the springs at the rigid beam connections being substantially equal to the spacing of the springs at the frame connections, and a drive to selectively impart displacement to and control the displacement of the rigid beam.

24. The interferometer of claim 23 further including a laser source, an infrared source, a fixed mirror, a beam splitter, a laser detector and an infrared detector.

25. The interferometer of claim 24 including an optical energy transmission system to direct the laser and infrared energy simultaneously through the beam splitter to be split toward both the fixed and movable mirrors and then to be recombined at the beam splitter.

26. An integral one piece support for a movable mirror comprising a rigid beam section, a rigid mount section and at least two springs extending between and connecting the rigid beam and mount sections, the movable mirror being mounted to the rigid beam, the spacing between the at least two springs at the rigid beam section equaling the spacing between the at least two springs at the rigid mount section.
